(19) United States
(12) Patent Application Publication
(10) Pub. No.: US 2014/0236480 A1
(43) Pub. Date: Aug. 21, 2014

(54) REAL-TIME MOVEMENT PATH ESTIMATION APPARATUS AND METHOD USING VISIBLE LIGHT COMMUNICATION

(71) Applicant: Electronics and Telecommunications Research Institute, Daejeon-city (KR)

(72) Inventors: Hyun-Chul Kang, Daejeon (KR); Tae-Gyu Kang, Daejeon (KR); Jung-Sik Sung, Daejeon (KR); Hyun-Joo Kang, Daejeon (KR); Myung-Soon Kim, Daejeon (KR); Seong-Hee Park, Daejeon (KR); Sang-Kyu Lim, Daejeon (KR); Il-Soon Jang, Daejeon (KR); You-Jin Kim, Daejeon (KR); Dae-Ho Kim, Daejeon (KR); Hyun-Seok Kim, Daejeon (KR); In-Su Kim, Daejeon (KR); Hyun-Jong Kim, Chungcheongbuk-do (KR); Jin-Doo Jeong, Daejeon (KR)

(73) Assignee: Electronics and Telecommunications Research Institute, Daejeon-city (KR)

(21) Appl. No.: 14/018,468

(22) Filed: Sep. 5, 2013

(30) Foreign Application Priority Data
Feb. 20, 2013 (KR) 10-2013-0017955

(51) Int. Cl. G01C 21/00

(52) U.S. Cl. CPC G01C 21/00
USPC 701/519

(57) ABSTRACT

The present invention relates to a real-time movement path estimation apparatus using visible light communication. A server for performing communication with an agent for tracking a location of a client which is a target to be tracked includes an agent management unit for setting the agent and the client. A server communication unit receives management information of the agent at intervals of a preset monitoring period. A path prediction unit derives a predicted path for a movement path of the client, based on the location information of the client included in the management information and tracked by a location determination device including a visible light communication device or an image capturing device in the agent.

### CROSS REFERENCE TO RELATED APPLICATION

This application claims the benefit of Korean Patent Application No. 10-2013-0017955 filed on Feb. 20, 2013, which is hereby incorporated by reference in its entirety into this application.

### BACKGROUND OF THE INVENTION

1. Technical Field

The present invention relates generally to an apparatus and method for estimating the movement path of a target to be tracked and, more particularly, to an apparatus and method for estimating the movement path of a target to be tracked in real time using visible light communication.

2. Description of the Related Art

Recently, with the rapid development of mobile communication technology, various types of location-based tracking technologies using wireless communication technology have been developed in different forms. Generally, a positioning system based on a Global Positioning System (GPS) and a location tracking service using Radio Frequency Identification (RFID) technology have been developed and utilized.

However, the provision of an automated real-time location tracking service to detect the location or state information of a specific object has many limitations. That is, it is possible to attach wireless communication or positioning equipment (for example, a GPS, RFID, Wireless Fidelity (Wi-Fi), Wireless Local Area Network (WLAN), or another communication device) to a specific object, and identify the information of the object. However, when the path of any target is tracked in real-time, it is difficult to track the path without requiring the above-described wireless communication or positioning equipment and without utilizing a specific location tracking service. Further, a specific person or object to which a location tracking device such as a GPS is not attached may be present. In this case, there is a problem in that a lot of time and effort are required to individually analyze pieces of data collected by imaging equipment, such as a Closed Circuit Television (CCTV), from a predicted path which is expected as a movement path, and to determine the movement path and location of the person or object based on the analyzed data.

In relation to this, there is conventional technology disclosed in Korean Patent Application Publication No. 10-2003-0015414 entitled “Positioning apparatus and method for cellular mobile communication system.”

### SUMMARY OF THE INVENTION

Accordingly, the present invention has been made keeping in mind the above problems occurring in the prior art, and an object of the present invention is to provide a real-time movement path estimation apparatus, which tracks the location and path of a client that is a target, the location of which is to be tracked, without requiring positioning equipment such as a GPS, RFID, Wi-Fi or WLAN device.

Another object of the present invention is to provide a real-time movement path estimation apparatus, which can improve the accuracy of the estimation of the location of a client.

In accordance with an aspect of the present invention to accomplish the above objects, there is provided a server for performing communication with an agent for tracking a location of a client which is a target to be tracked, including an agent management unit for setting the agent and the client; a server communication unit for receiving management information of the agent at intervals of a preset monitoring period; and a path prediction unit for deriving a predicted path for a movement path of the client, based on the location information of the client included in the management information and tracked by a location determination device including a visible light communication device or an image capturing device in the agent.

Preferably, the server may further include a statistical data generation unit for receiving an actual movement path of the client from the agent through the server communication unit, and generating feedback information by comparing the actual movement path with the predicted path.

Preferably, the statistical data generation unit may further generate statistical data used to derive the predicted path based on the feedback information.

Preferably, the agent management unit may include an agent setting module for setting an agent desired to be managed in response to input from a user; and a client setting module for setting a client desired to be tracked in response to the input from the user.

Preferably, the agent management unit may be configured to, if the client is changed through the client setting module, generate client list information, and then transmit the client list information to the agent through the server communication unit.

Preferably, the agent management unit may include a monitoring period setting module for variably adjusting the monitoring period in response to input from a user.

Preferably, the agent management unit may be configured to, if information about the client is not included in the management information, collect management information of the agent through the server communication unit until information about the client is received.

Preferably, the server communication unit may be configured to, if a monitoring stop request is received from a user, transmit monitoring stop request information to the agent.

In accordance with another aspect of the present invention to accomplish the above objects, there is provided an agent for tracking a location of a client which is a target to be tracked, including an agent communication unit for receiving client list information including a client which is a target to be tracked from a server; a location determination device search unit for searching for a location determination device including a visible light communication device or an image capturing device; and a location determination unit for determining location information of the client using the found location determination device, wherein the agent communication unit transmits the location information of the client determined by the location determination unit to the server.

Preferably, the location determination unit may be configured to, if the image capturing device is present in the location determination device, identify the client using the image capturing device and determine the location of the client based on video and audio information of the identified client.

Preferably, the location determination unit may be configured to, if an image capturing device is not present and a visible light communication device is present in the location determination device, determine whether visible light communication with other agents falling within a preset range is possible.

Preferably, the location determination unit may be configured to, if the visible light communication is possible, compare pieces of location information of the client tracked by the other agents falling within the preset range with each other and receive the location information of the client if the pieces of location information of the client tracked by the other agents are identical to each other.

Preferably, the location determination unit may be configured to, if pieces of location information of the client are not identical to each other, monitor a location determination device at intervals of a preset monitoring period.

Preferably, the location determination unit may be configured to, if neither the image capturing device nor the visible light communication device is present in the location determination device, determine the location of the client based on the client list information.

Preferably, the agent may further include a validity verification unit for mapping the client list information transmitted from the server to client list information included in the management information of the agent, and verifying validity of the client list information transmitted from the server.

Preferably, if monitoring stop request information is received from the server, internal processing of the agent may be stopped.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing a real-time movement path estimation apparatus according to an embodiment of the present invention;

FIG. 2 is a block diagram showing a server included in the real-time movement path estimation apparatus according to the present invention;

FIG. 3 is a block diagram showing an agent management unit included in the server of the real-time movement path estimation apparatus according to the present invention;

FIG. 4 is a block diagram showing an agent included in the real-time movement path estimation apparatus according to the present invention;

FIG. 5 is a flowchart showing the operation process of the server included in the real-time movement path estimation apparatus according to the present invention;

FIG. 6 is a flowchart showing the operation process of an agent management unit included in the server of the real-time movement path estimation apparatus according to the present invention;

FIG. 7 is a flowchart showing the operation process of an agent included in the real-time movement path estimation apparatus according to the present invention; and

FIG. 8 is a flowchart showing the operation process of a location determination unit included in the agent of the real-time movement path estimation apparatus according to the present invention.

### DESCRIPTION OF THE PREFERRED EMBODIMENTS

The present invention will be described in detail below with reference to the accompanying drawings. In the following description, redundant descriptions and detailed descriptions of known functions and elements that may obscure the gist of the present invention will be omitted. Embodiments of the present invention are provided to fully describe the present invention to those having ordinary knowledge in the art to which the present invention pertains. Accordingly, in the drawings, the shapes and sizes of elements may be exaggerated for the sake of clearer description.

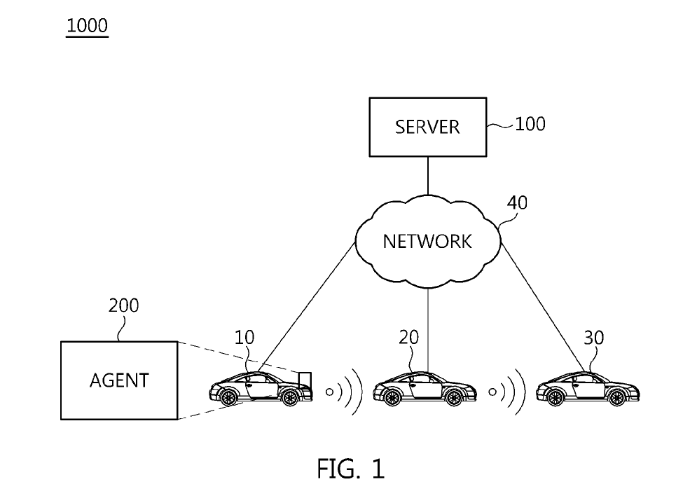

Hereinafter, a real-time movement path estimation apparatus 1000 according to an embodiment of the present invention will be described in detail with reference to FIG. 1. FIG. 1 is a diagram showing the real-time movement path estimation apparatus 1000 according to an embodiment of the present invention.

As shown in FIG. 1, the real-time path estimation apparatus 1000 according to the embodiment of the present invention mainly includes a server 100 and an agent 200. The individual components included in FIG. 1 will be described in detail below.

The server 100 functions to set a client 30 which is a target to be tracked and an agent 200 which is a target to be managed, depending on the manipulation of a user. Further, the server 100 functions to periodically monitor information collected from the agent 200 and determine whether event information is present. The event information denotes pieces of information, such as the location change or error information of the client 30. Furthermore, the server 100 may function to determine the location information of the client 30 according to the management information transmitted from the agent 200, and to predict the movement path of the client 30 based on the determined location information. Furthermore, after receiving the actual movement path of the client 30, the server 100 may report the actual movement path and the predicted path to the user at the request of the user. Furthermore, the server 100 may improve the accuracy of location tracking and the derivation of a predicted path in conjunction with an external system. Furthermore, the server 100 may receive the actual movement path and location information of the client 30 and calculate feedback information by comparing the actual movement path of the client with the predicted path. The server 100 may generate statistical data based on the calculated feedback information and store the generated statistical data in a separate storage unit. The statistical data stored in this way may be used as data required to improve the accuracy of subsequent predictions.

The agent 200 functions to receive a management list including clients, which are targets to be tracked, from the server 100 and track the location of the corresponding client 30. Here, the agent 200 searches for a location determination device in the agent 200 when tracking the location of the client 30. The reason for this is that a location determination device present within a vehicle or an object may differ according to the vehicle or the object equipped with the agent 200, and a location tracking method must also differ according to the present location determination device. In this case, the location determination device may be defined as a device usable in the agent 200. Accordingly, the location determination device denotes, for example, a camera, a communication device, a Visible Light Communication (VLC) device, a black box, an audio device, a display device, etc. If the location determination device is found, the agent 200 determines the location information of the client 30 via the found location determination device. Thereafter, the agent 200 transmits the determined location information of the client 30 to the server 100.

Referring back to FIG. 1, a first vehicle 10, a second vehicle 20, a third vehicle 30, and a network 40 are shown. Here, in each of the first, second and third vehicles 10, 20, and 30, the agent 200 according to the present invention may be mounted. As described above, the agent 200 is a device capable of tracking the location of a client which is a target to be tracked. The third vehicle 30 is assumed to be a client 30 which is a target to be tracked. Further, as in the case of the present embodiment, the client 30 may be equipped with the agent 200, but may be defined as a specific object to which the agent 200 and a separate communication device are not attached. The agent 200 may track the location of the client 30 at the request of the server 100 and transmit the tracked location information to the server 100. Here, when the tracked location information is transmitted to the server 100, various communication techniques based on a wireless network, such as a 3rd generation (3G), 4th generation (4G) (long term evolution: LTE), Wi-Fi, Wibro, visible light communication, Zigbee, WAVE (Wireless Access in Vehicular Environment), RF communication, and WLAN communication, may be used. Here, visible light communication is communication technology for transferring information using visible light. That is, visible light communication denotes a technique for turning on and off light emitted from a fluorescent lamp or visible light emitted from a light emitting diode at a speed which cannot be perceived by human eyes, and transmitting and receiving signals using the light. Accordingly, the user may determine the location information of the client 30 through the server 100.

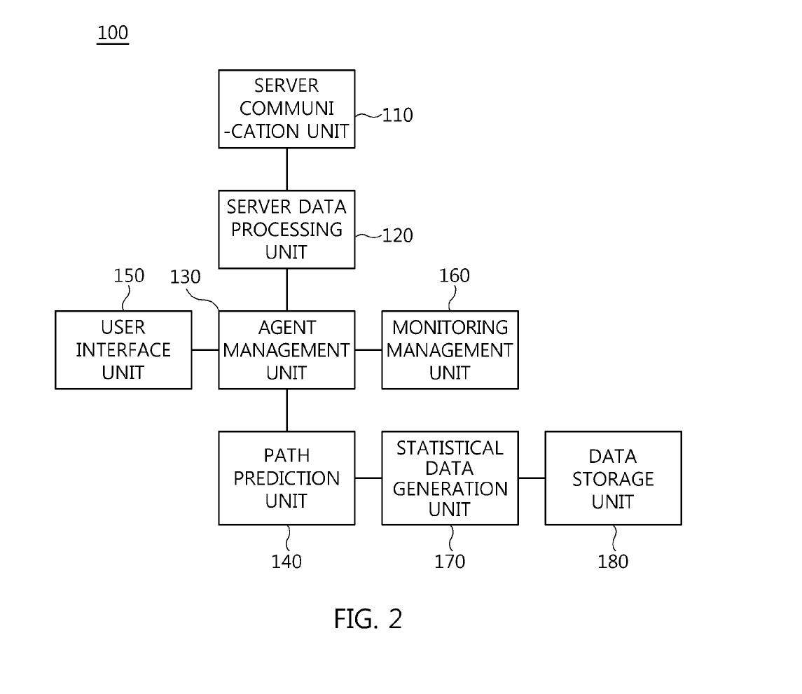

Hereinafter, the server 100 included in the real-time movement path estimation apparatus 1000 according to the present invention will be described with reference to FIG. 2. FIG. 2 is a block diagram showing the server 100 included in the real-time movement path estimation apparatus 1000 according to the present invention.

As shown in FIG. 2, the server 100 included in the real-time movement path estimation apparatus 1000 according to the present invention may include a server communication unit 110, a server data processing unit 120, an agent management unit 130, a path prediction unit 140, a user interface unit 150, a monitoring management unit 160, a statistical data generation unit 170, and a data storage unit 180. Below, the individual components included in the server 100 will be described in detail.

The server communication unit 110 may receive information collected from an agent or transmit data. Further, the server communication unit 110 may utilize all available resources that can be communicated to the agent. That is, when communicating with the agent, the server communication unit 110 may perform communication with the agent using various communication techniques including the above-described 3G, 4G (LTE), Wi-Fi, Wibro, visible light communication, Zigbee, WAVE, RF communication, and WLAN communication.

The server data processing unit 120 functions to process information collected from the agent and internally process all events that are processed within the server.

The agent management unit 130 functions to register, change or delete and manage an agent desired to be managed by the server. A procedure performed by the agent management unit 130 may be set by input from the user, or the like. As described above with reference to FIG. 1, the agent denotes an object for transmitting and receiving data or information to and from the server of the real-time movement path estimation apparatus.

Further, the agent management unit 130 functions to register, change or detect a client which is a target to be tracked at the request of the user, and to manage the client. As described above, the client may be either one of objects including an agent or a specific object to which an agent or a separate communication device is not attached.

Furthermore, the agent management unit 130 may variably adjust a period at which monitoring is performed through the agent in response to the input from the user.

The path prediction unit 140 functions to predict the movement path of the client based on the location information of the client received from the agent through the server communication unit 110. In this case, the location information of the client may be included in the management information of the agent and may be transmitted from the agent to the server. Further, the management information of the agent is information including identifier information required to independently identify the agent. Furthermore, the management information of the agent may include various types of information, for example, information about devices, the area information, address, vehicle license plate number, color, location, type, and user of a place in which the agent is located, a monitoring event (for example, whether monitoring has been performed), and client information, depending on types that can be collected by the server. Further, the client information may include client list information, identifiers of clients, and the location information of the clients. Here, the client list information denotes information about a list on which pieces of information about clients to be tracked are recorded by the agent management unit 130.

The user interface unit 150 is implemented as an interface allowing an operator or a user to check and search for the information of the server, that is, the location information of the client to be tracked, the predicted path of the client, the movement path of the client, etc. Accordingly, the user interface unit 150 may include a separate input module, a separate output module, etc. Here, the output module is a module for outputting the user's desired data to the user and may be configured to include a speaker, a display device, or the like. Further, the user interface unit 150 may receive a command, such as the termination of the tracking of the location of the client 30, from the user through the separate input module.

The monitoring management unit 160 functions to check whether event information is present in the information collected from the agent at intervals of a preset monitoring period. As described above, the event information denotes pieces of information, such as the location change or error information of the client 30. Further, the preset monitoring period may be variably adjusted by the agent management unit 130 depending on the input from the user.

The statistical data generation unit 170 functions to receive the actual movement path and location information of the client and then calculate feedback information by comparing the actual movement path with the predicted path. Further, the statistical data generation unit 170 functions to calculate statistical data required to obtain the accuracy of the derivation of the predicted path by the path prediction unit 140 based on the feedback data calculated in this way.

The data storage unit 180 stores all pieces of information processed in the server. That is, the data storage unit 180 may store data or information processed by the above-described components, for example, the management information of the agent, the feedback data, and the statistical data, etc. Further, the data storage unit 180 may be independently present at a separate location without being included in the server, and may exchange data with other components through the server communication unit 110.

The server 100 may further include an external system interaction unit (not shown) and may additionally acquire the location information of the client. By means of this configuration, the server 100 may further improve the accuracy of the acquisition of the location of the client 30. Accordingly, the server 100 may produce more accurate results when generating statistical data and deriving the predicted path of the client.

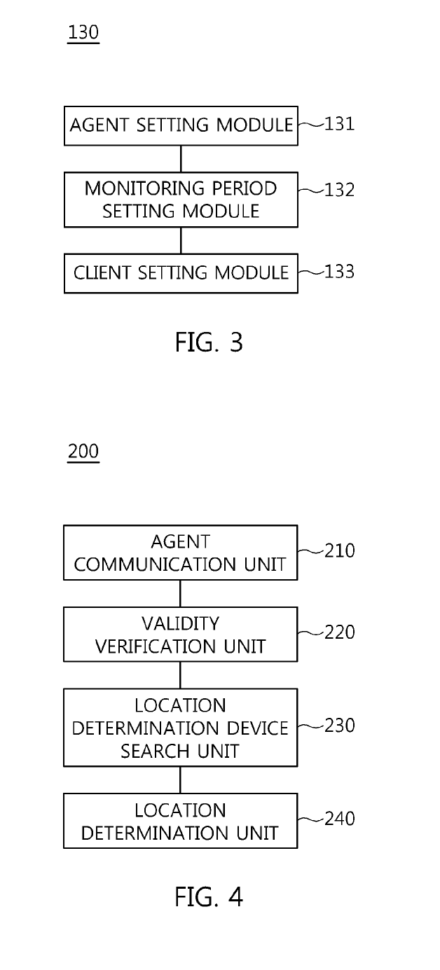

Below, the agent management unit 130 included in the server of the real-time movement path estimation apparatus according to the present invention will be further described with reference to FIG. 3. FIG. 3 is a block diagram showing the agent management unit 130 included in the server of the real-time movement path estimation apparatus according to the present invention. The agent management unit 130 includes an agent setting module 131, a monitoring period setting module 132, and a client setting module 133.

The agent setting module 131 functions to set an agent desired to be managed in response to input from the user. That is, the agent setting module 131 functions to determine whether the information type of the agent is new, changed, or deleted, and to incorporate the management information of the agent according to the type. Further, the agent setting module 131 updates the management information of a changed agent. That is, detailed information, such as the identifier and device of the agent and the location, area information, address, phone number, email, user, and number of a place at which the agent is located, is updated. As described above, the management information of the agent is information including various types of information depending on the types that can be collected by the server. Therefore, it should be understood that attributes of the management information of the agent may be changed or added by the user.

The monitoring period setting module 132 functions to variably adjust a monitoring period in response to the input from the user. That is, the monitoring period setting module 132 functions to determine whether the monitoring period managed by the monitoring management unit described with reference to FIG. 2 has been set or changed, and to incorporate the set information. As described above, the monitoring period denotes a period used when the server and the agent determine whether an event is present.

The client setting module 133 functions to set a client desired to be tracked in response to the input from the user. In greater detail, the client setting module 133 determines whether a request from the user to input, change, or delete the client which is a target to be tracked has been applied to the server. If the request to input, change or delete the client has been applied to the server, the client setting module 133 incorporates the corresponding details into the list of clients. Thereafter, the client setting module 133 stores such details.

Below, the agent 200 included in the real-time movement path estimation apparatus according to the present invention will be described with reference to FIG. 4. FIG. 4 is a block diagram showing the agent 200 included in the real-time movement path estimation apparatus according to the present invention. Referring to FIG. 4, the agent 200 according to the embodiment of the present invention includes an agent communication unit 210, a validity verification unit 220, a location determination device search unit 230, and a location determination unit 240.

The agent communication unit 210 functions to receive client list information including a client which is a target to be tracked from the server. In detail, the agent communication unit 210 functions to communicate the management information of the server and the agent and mutual data between the server and the agent. Further, the agent communication unit 210 functions to transmit information collected from the agent to the server, or receive data from the server. Further, in the following description, the location information of the client, determined by the location determination unit 240, may be transmitted to the server.

The validity verification unit 220 functions to map the client list information transmitted from the server to client information included in the management information of the agent and then verify and analyze the validity of the client list information transmitted from the server. Further, the validity verification unit 220 functions to check the management information of the agent, in detail, the information of the client included in the client list information. Furthermore, the validity verification unit 220 determines whether to continuously monitor the client based on the client list information. In addition, if monitoring stop request information is received from the server through the agent communication unit, the validity verification unit 220 functions to stop monitoring and terminate the internal processing of the agent.

The location determination device search unit 230 functions to search for a location determination device within the agent. The reason for this is that, as described above with reference to FIG. 1, a location determination device present in a vehicle or an object may differ according to the vehicle or the object on which the agent 200 is mounted, and a location tracking method must also differ according to the present location determination device. Further, the location determination device may be defined as a device usable in the agent 200. That is, the location determination device may be described as, for example, a device including a camera, a communication device, a Visible Light Communication (VLC) device, a black box, an audio device, or a display device.

The location determination unit 240 functions to determine the location information of the client through the location determination device found by the location determination device search unit 230. As described above, since a location determination method must differ according to the type of location determination device present in the vehicle or the object, different location determination methods are performed depending on the found location determination device. For example, when the agent 200 tracks the location of the client, a VLC device may be present in the vehicle or the object in which the agent 200 is mounted, but an image-capturing device, such as a camera, may not be present in the vehicle or the object. In contrast, when the agent 200 tracks the location of the client, an image capturing device may be present in the vehicle or the object in which the agent 200 is mounted, but a VLC device may not be present. Further, when the agent 200 tracks the location of the client, neither an image capturing device nor a VLC device may be present in the vehicle or the object in which the agent 200 is mounted. The location determination unit 240 may perform location determination in consideration of these cases. That is, when an image capturing device is present among location determination devices, the location determination unit 240 may identify the client using the image capturing device and determine the location of the client based on the video and audio information of the identified client. Further, when an image capturing device is not present and a VLC device is present among location determination devices, the location determination unit 240 determines whether visible light communication with other agents falling within a preset range is possible. In this case, if it is determined that visible light communication is possible, the location determination unit 240 compares pieces of location information of the client tracked by other agents falling within the preset range with each other. By means of this comparison, if the pieces of location information are found to be identical to each other, the location determination unit 240 may receive the location information of the client from the other agents and determine the location of the client based on the received location information of the client. Further, if the pieces of location information are not identical to each other, a location determination device is continuously monitored at intervals of a preset monitoring period and is re-searched for, and then a location determination procedure using the found location determination device is repeated. Further, if neither an image capturing device nor a VLC device is present, the location determination unit 240 performs a procedure for causing the user to check whether to use the location of the client included in the client list information. Here, if the user agrees with the use of location, the location determination unit 240 determines the location of the client based on information stored in the client list information. Further, if both an image capturing device and a VLC device are present, the location determination unit 240 may utilize both a procedure based on the image capturing device and a procedure based on the VLC device, or may selectively utilize the image capturing device or the VLC device.

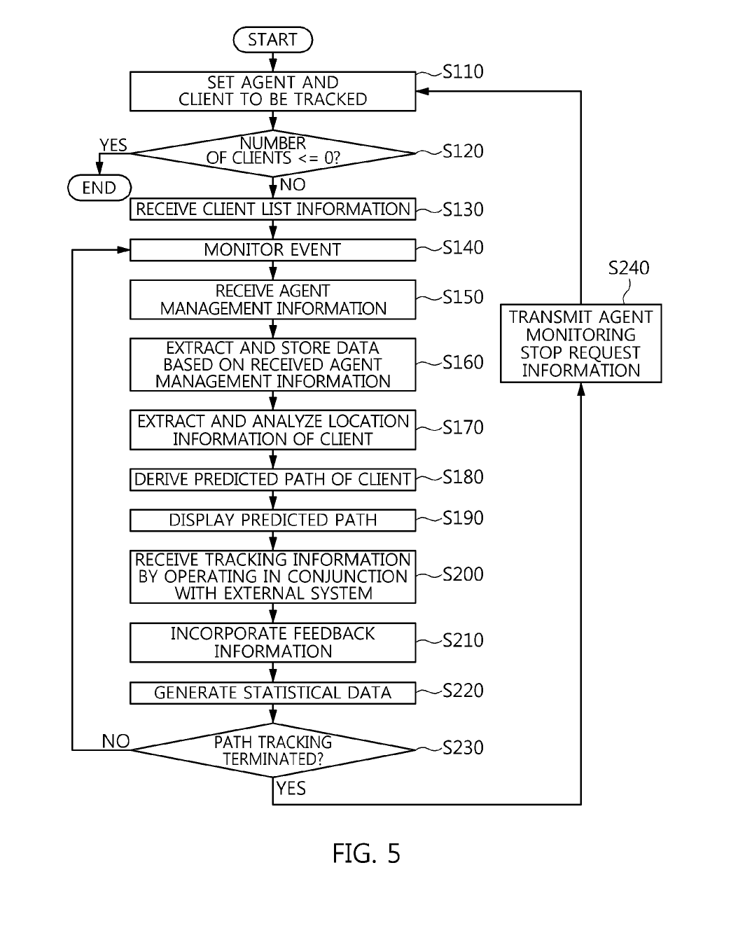

Hereinafter, the operation process of the server included in the real-time movement path estimation apparatus will be described in detail with reference to FIG. 5. FIG. 5 is a flowchart showing the operation process of the server included in the real-time movement path estimation apparatus according to the present invention. It should be understood that details described in the above apparatus are omitted for the simplicity of the description of the present specification.

First, at step S110, an agent and a client, which is a target to be tracked, are set by the agent management unit included in the server. At step S110, as described above with reference to FIGS. 2 and 3, the function of setting an agent which is a target to be managed and a client which is a target to be tracked is performed in response to input from a user or an operator. At step S110, the management information of the agent is collected from the agent at intervals of a preset monitoring period, and a request for synchronization with the agent management information may be made. Since a description of this procedure has been made in detail with reference to FIGS. 2 and 3, a description thereof will be omitted here. After the setting of the agent to be managed and the client to be tracked has been completed, the control proceeds to step S120.

At step S120, it is determined whether any set client is present via the agent management unit included in the server. That is, if it is determined that the client to be tracked is present, the control proceeds to step S130, whereas if it is determined that the client to be tracked is not present, the control proceeds to termination.

At step S130, the client list information generated at step S110 is transmitted to the agent through the server communication unit included in the server. After such a transmission procedure has been completed, the control proceeds to step S140.

At step S140, it is determined via monitoring whether event information from the agent is present by using the monitoring management unit included in the server. At step S140, if the agent management information is received, the control proceeds to step S150, otherwise monitoring is continuously performed until agent management information is received.

At step S150, the agent management information is received, and data included in the agent management information is extracted and stored. Here, the agent management information and the extracted data may be stored in the data storage unit. After such a procedure has been completed, the control proceeds to step S160.

At step S160, data related to the tracking of the path of the client is extracted based on the agent management information received at step S150, and the extracted data is analyzed.

Thereafter, at step S170, the location information of the client is extracted and analyzed based on the data related to the tracking of the path of the client and extracted and analyzed at step S160. At step S170, the server may recognize the location information of the client. Here, steps S150 to S170 are performed by the server data processing unit included in the server. After the extraction and analysis procedure has been completed, the control proceeds to step S180.

At step S180, a predicted path for the movement path of the client is derived based on the location information of the client analyzed at step S170. Step S180 may be performed by the path prediction unit included in the server. Here, the method of deriving the path is configured to, as described above with reference to FIG. 2, derive the predicted path based on the statistical data stored in the data storage unit and the current location information of the client. After a derivation procedure has been completed, the control proceeds to step S190.

At step S190, the current location of the client, the movement path of the client detected to date, and the predicted path derived at step S180 are reported to the user. Here, when the current location of the client, the movement path of the client detected to date, and the predicted path derived at step S180 are reported to the user, at least one of audio and display schemes may be used. Step S190 may be performed by the user interface unit included in the server. After this procedure has been completed, the control proceeds to step S200.

Step S200 is a step selectively performed to improve the accuracy of a procedure for deriving the predicted path of the client performed at step S180, and is the step where data related to the predicted path derivation procedure is received by operating in conjunction with an external system through the external system interaction unit. This step may be used when it is difficult to track the location of the client using only data provided by the agent or when it is desired to further improve the accuracy of location tracking. After this reception step has been completed, the control proceeds to step S210.

At step S210, the actual path is compared with the predicted path derived at step S180, based on the current location of the client and the movement path of the client received above. By means of this comparison procedure, feedback information is generated. After the feedback information has been generated and incorporated, the control proceeds to step S220.

At step S220, statistical data is generated based on the feedback information incorporated at step S210. As described above, the statistical data improves the accuracy of derivation when the predicted path is derived at step S180. Here, steps S210 and S220 may be performed by the statistical data generation unit included in the server. Further, the feedback information and the statistical data generated at steps S210 and S220 may be stored in the data storage unit included in the server.

At step S230, it is determined whether the tracking of the path has been terminated. Step S230 is configured to determine whether the tracking of the path has been terminated by the operator or the user, or by system input. In this case, if it is determined that the tracking of the path has been terminated, the control proceeds to step S240, otherwise the control returns to step S140 where the above-described steps are repeated.

At step S240, agent monitoring stop request information is transmitted to the agent through the server communication unit. By means of this step, the agent may terminate the tracking of the location of the client. Steps S230 and S240 may be performed by the data processing unit included in the server. After the transmission procedure has been completed, the control returns to step S110.

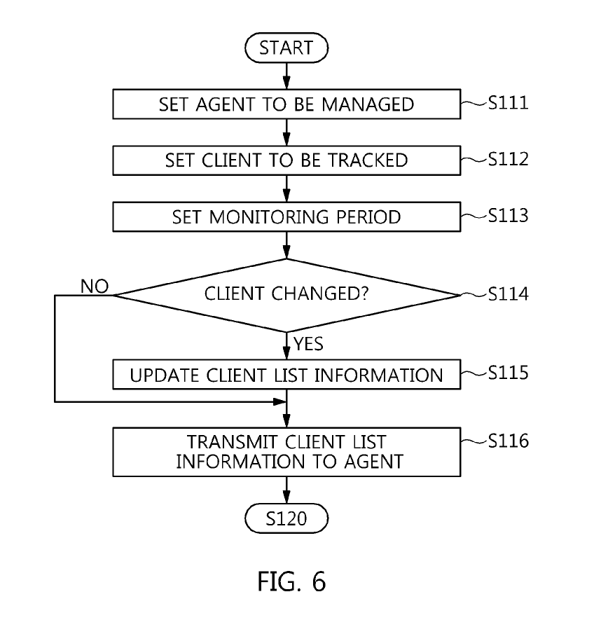

Below, the operation process of the agent management unit included in the server of the real-time movement path estimation apparatus according to the present invention will be described with reference to FIG. 6. FIG. 6 is a flowchart showing the operation process of the agent management unit included in the server of the real-time movement path estimation apparatus according to the present invention. In the following description, it should be understood that details described with reference to FIG. 3 will be omitted here for the simplicity of the description of the present specification.

First, at step S111, an agent which is a target to be managed is set in response to input from the user. That is, step S111 is the step of setting an agent desired to be managed in response to the input from the user. In greater detail, step S111 is configured to determine whether the information type of the agent is new, changed or deleted in response to the input from the user and incorporate the management information of the agent into the agent according to the type. Thereafter, step S111 is configured to update the management information of the agent based on the incorporated agent. Since a description of the management information of the agent has been made above with reference to FIG. 3, a description thereof will be omitted here. The management information of the agent updated in this way may be stored in the data storage unit. Step S111 may be performed by the agent setting module included in the agent management unit of the server. After the procedure has been completed, the control proceeds to step S112.

At step S112, a client which is a target to be tracked is set in response to input from the user. That is, step S112 is the step of setting the client desired to be tracked in accordance with the input from the user. In detail, step S112 is configured to determine whether a request from the user to input, change, or delete the client to be tracked has been applied to the server. Thereafter, at step S112, if the request to input, change or delete the client has been applied to the server, the client is set in response to the request. Step S112 may be performed by the client setting module included in the agent management unit of the server. After the client setting procedure has been completed, the control proceeds to step S113.

At step S113, a monitoring period is set according to the input from the user. That is, step S113 is configured to determine whether a monitoring period managed by the monitoring management unit described with reference to FIG. 2 has been set or changed, and to incorporate setting information. Step S113 may be performed by the monitoring period setting module included in the agent management unit of the server. After the monitoring period setting procedure has been completed, the control proceeds to step S114.

At step S114, it is determined whether an existing client has changed. In greater detail, step S114 is the step of determining whether the client to be tracked, set at step S112, has been input, changed or deleted. In this case, if it is determined that the client has changed, the control proceeds to step S115, otherwise the control proceeds to step S116.

At step S115, when at least one of input, change, and deletion of the client has been performed, the corresponding details are incorporated and updated in the client list. At step S115, the updated client list is stored in the data storage unit included in the server. Thereafter, the control proceeds to step S116.

At step S116, the client list information is transmitted to the agent. Steps S114 to S116 may be performed by the client setting module included in the agent management unit of the server.

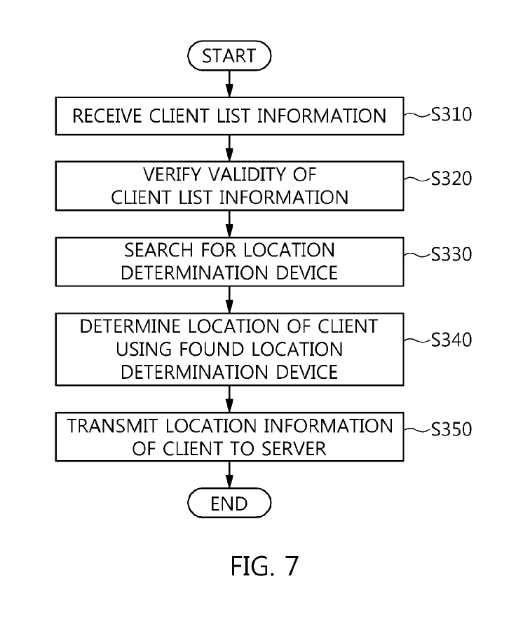

Below, the operation process of the agent included in the real-time movement path estimation apparatus according to the present invention will be described with reference to FIG. 7. FIG. 7 is a flowchart showing the operation process of the agent included in the real-time movement path estimation apparatus according to the present invention.

First, at step S310, client list information including a client which is a target to be tracked is received from the server. The client list information may be included in the management information of the agent. Therefore, if the management information of the agent is received from the server, the agent extracts the client list information included in the management information of the agent. Step S310 may be performed by the agent communication unit. After this reception procedure has been completed, the control proceeds to step S320.

At step S320, the client list information transmitted from the server is mapped to the information of the corresponding client included in the management information of the agent, and then the validity of the client list information transmitted from the server is verified. At step S320, the client information included in the management information of the agent, more specifically, the client list information, is checked. Further, at step S320, it is determined whether to continuously monitor the client, based on the client list information. At step S320, if monitoring stop request information is received from the server through the agent communication unit, monitoring is stopped and the internal processing of the agent is terminated. Step S320 may be performed by the validity verification unit included in the agent. After step S320 has been completed, the control proceeds to step S330.

At step S330, a location determination device including a VLC device or an image capturing device is searched for. Here, the location determination device is a device capable of determining the location of the client and has been described in detail above with reference to FIG. 4, and thus a detailed description thereof will be omitted here. Step S330 may be performed by the location determination device search unit of the agent. After the search procedure has been completed, the control proceeds to step S340.

At step S340, the location information of the client is determined by the location determination device found at step S330. As described above, a location determination method must differ according to the type of location determination device present in a vehicle or an object, and thus different location determination methods are performed according to the found location determination device. This location determination procedure is performed by the location determination unit included in the agent. After the determination of the location information has been completed, the control proceeds to step S350.

At step S350, the location information of the client determined at step S340 is transmitted to the server through the agent communication unit. Here, step S350 may be configured to, when the location information of the client is transmitted to the server, utilize available communication resources, for example, various communication techniques including 3G, 4G (LTE), Wi-Fi, Wibro, VLC, Zigbee, WAVE, RF communication, and WLAN communication.

The step of transmitting emergency monitoring standby request information to other agents located in an area adjacent to the client may be further performed. Further, according to the emergency monitoring period, if pieces of information about the client to be checked again are identical to each other, the corresponding information may be continuously collected, and the collected information may be transmitted to the server.

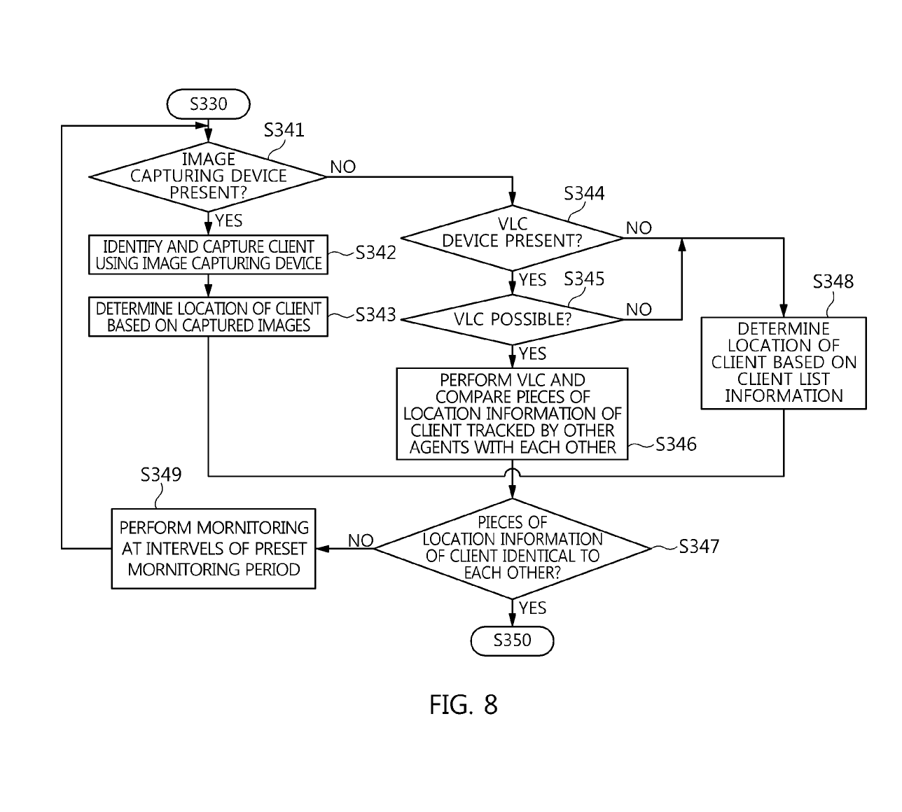

Below, the operation process of the location determination unit included in the agent of the real-time movement path estimation apparatus according to the present invention will be described with reference to FIG. 8. FIG. 8 is a flowchart showing the operation process of the location determination unit included in the agent of the real-time movement path estimation apparatus according to the present invention.

First, at step S341, it is determined whether an image capturing device, such as a camera or a black box, is present among location determination devices. At step S341, if it is determined that an image capturing device is present, the control proceeds to step S342, otherwise the control proceeds to step S344.

At step S342, a client is identified and captured using the image capturing device. That is, at step S342, it is determined whether a client to be tracked can be identified, using the image capturing device. Here, if it is determined that the identification of the client is possible, images of the client and the surrounding environment of the client are captured. After this procedure has been completed, the control proceeds to step S343.

Step S343 is the step of determining the location of the client based on the images captured at step S342. Step S343 may be directly performed by the location determination unit of the agent by recognizing a landmark or a surrounding environment. Further, at step S343, the captured images are transmitted to the server, thus allowing the user to personally determine the location of the client based on the surrounding environment. After such a location determination procedure has been completed, the control proceeds to step S350.

At step S344, it is determined whether an image capturing device is not present and a VLC device is present among the location determination devices. At step S344, if it is determined that the VLC device is present, the control proceeds to step S345, otherwise the control proceeds to step S348.

At step S345, it is determined using the VLC device whether VLC communication with other agents falling within a preset range is possible. A determination procedure at step S345 may be configured such that, for example, if other agents falling within a preset range are capable of receiving VLC sample data when the VLC sample data is sent to the other agents, it is determined that VLC communication is possible. If it is determined at step S345 that VLC communication is possible, the control proceeds to step S346, otherwise the control proceeds to step S348.

At step S346, pieces of location information of the client tracked by the other agents falling within the preset range are compared with each other. After such a comparison procedure has been completed, the control proceeds to step S347.

At step S347, it is determined via comparison whether pieces of location information of the client stored in the other agents are identical to each other. If it is determined that the pieces of location information are identical to each other, it is determined that the location information of the client is correct data, and surrounding information including the location information of the client, for example, time, date, location, place, related video and audio information, etc., is stored. Thereafter, the control proceeds to step S350, otherwise the control proceeds to step S349.

At step S349, the monitoring of a location determination device is performed at intervals of a preset monitoring period. At step S349, a location determination device is re-searched via step S330, and then the control returns to step S341 where the above procedures are repeated.

Step S348 is performed when it is determined that neither an image capturing device nor a VLC device is present among location determination devices. First, the user is caused to check whether to use the location of the client included in the client list information. In this case, if the user agrees with the use of location, the location of the client is determined based on the information stored in the client list information.

In accordance with a real-time movement path estimation apparatus according to the present invention, the location and path of a client-the location of which is to be tracked can be tracked without requiring positioning equipment, such as a GPS, RFID, Wi-Fi, or WLAN device.

Further, the real-time movement path estimation apparatus according to the present invention is advantageous in that the accuracy of location estimation corresponding to a client can be improved using feedback information generated based on the actual location information of the client transmitted from the agent and statistical data generated based on the feedback information.

Furthermore, the real-time movement path estimation apparatus according to the present invention is advantageous in that it can be utilized in various fields, such as the application of a target to be searched for, tracking of stolen vehicles corresponding to a location-related service, resource management, and traffic prediction.

As described above, optimal embodiments of the present invention have been disclosed in the drawings and the specification. Although specific terms have been used in the present specification, these are merely intended to describe the present invention and are not intended to limit the meanings thereof or the scope of the present invention described in the accompanying claims. Therefore, those skilled in the art will appreciate that various modifications and other equivalent embodiments are possible from the embodiments. Therefore, the technical scope of the present invention should be defined by the technical spirit of the claims.

What is claimed is:

1. A server for performing communication with an agent for tracking a location of a client which is a target to be tracked, comprising:
an agent management unit for setting the agent and the client;
a server communication unit for receiving management information of the agent at intervals of a preset monitoring period; and
a path prediction unit for deriving a predicted path for a movement path of the client, based on the location information of the client included in the management information and tracked by a location determination device including a visible light communication device or an image capturing device in the agent.

2. The server of claim 1, further comprising a statistical data generation unit for receiving an actual movement path of the client from the agent through the server communication unit, and generating feedback information by comparing the actual movement path with the predicted path.

3. The server of claim 2, wherein the statistical data generation unit further generates statistical data used to derive the predicted path based on the feedback information.

4. The server of claim 1, wherein the agent management unit comprises:
an agent setting module for setting an agent desired to be managed in response to input from a user; and
a client setting module for setting a client desired to be tracked in response to the input from the user.

5. The server of claim 4, wherein the agent management unit is configured to, if the client is changed through the client setting module, generate client list information, and then transmit the client list information to the agent through the server communication unit.

6. The server of claim 1, wherein the agent management unit comprises a monitoring period setting module for variably adjusting the monitoring period in response to input from a user.

7. The server of claim 1, wherein the agent management unit is configured to, if information about the client is not included in the management information, collect management information of the agent through the server communication unit until information about the client is received.

8. The server of claim 1, wherein the server communication unit is configured to, if a monitoring stop request is received from a user, transmit monitoring stop request information to the agent.

9. An agent for tracking a location of a client which is a target to be tracked, comprising:
an agent communication unit for receiving client list information including a client which is a target to be tracked from a server;
a location determination device search unit for searching for a location determination device including a visible light communication device or an image capturing device; and
a location determination unit for determining location information of the client using the found location determination device,
wherein the agent communication unit transmits the location information of the client determined by the location determination unit to the server.

10. The agent of claim 9, wherein the location determination unit is configured to, if the image capturing device is present in the location determination device, identify the client using the image capturing device and determine the location of the client based on video and audio information of the identified client.

11. The agent of claim 9, wherein the location determination unit is configured to, if an image capturing device is not present and a visible light communication device is present in the location determination device, determine whether visible light communication with other agents falling within a preset range is possible.

12. The agent of claim 11, wherein the location determination unit is configured to, if the visible light communication is possible, compare pieces of location information of the client tracked by the other agents falling within the preset range with each other and receive the location information of the client if the pieces of location information of the client tracked by the other agents are identical to each other.

13. The agent of claim 11, wherein the location determination unit is configured to, if pieces of location information of the client are not identical to each other, monitor a location determination device at intervals of a preset monitoring period.

14. The agent of claim 9, wherein the location determination unit is configured to, if neither the image capturing device nor the visible light communication device is present in the location determination device, determine the location of the client based on the client list information.

15. The agent of claim 9, further comprising a validity verification unit for mapping the client list information transmitted from the server to client list information included in the management information of the agent, and verifying validity of the client list information transmitted from the server.

16. The agent of claim 9, wherein if monitoring stop request information is received from the server, internal processing of the agent is stopped.
